(19) United States
(12) Patent Application Publication
(10) Pub. No.: US 2006/0258557 A1
(43) Pub. Date: Nov. 16, 2006

(54) Hard surface cleaning compositions and methods for making same

(76) Inventors: Lewis Michael Popplewell, Morganville, NJ (US); Ray Guerry, Red Bank, NJ (US); Yueqian Zhen, Tredyffrin, PA (US); Carol Joyce, Toms River, NJ (US)

Correspondence Address: INTERNATIONAL FLAVORS & FRAGRANCES INC., 521 WEST 57TH ST, NEW YORK, NY, 10019, US

(21) Appl. No.: 11/126,617

(22) Filed: May 11, 2005

(51) Int. Cl. C11D 3/37

(52) U.S. Cl. 510/499

(57) ABSTRACT

The present invention is directed to hard surface cleaning compositions comprising encapsulated fragrances and/or malodour counteractants and methods for making the same. These compositions are well suited for use in cleaning toilet bowls, baths, shower surrounds and other plumbing fixtures, bathroom and kitchen hard surfaces, glass windows and floor surfaces.

### FIELD OF THE INVENTION

The present invention is directed to hard surface cleaning compositions comprising encapsulated fragrances and/or malodour counteractants and methods for making the same. These compositions appear to be especially well suited for use in cleaning toilet bowls, baths, shower surrounds and other plumbing fixtures, bathroom and kitchen hard surfaces, glass windows, and floor surfaces.

### BACKGROUND OF THE INVENTION

Hard surface cleaners should be suitable for use on a wide variety of surfaces and effective against different types of soil deposits, e.g. grease, heel scuff marks, food spills, dirt buildup, wax buildup, mildew, and the like. Preferably, the cleaner should not exhibit a high degree of sudsing so as to minimize streaking when used on highly polished surfaces, for example, glass surfaces, bathroom tiles, marble and terrazzo floors, and counter tops. Cleaners in concentrate form are particularly advantageous because the degree of dilution can be regulated depending upon the nature of the surface to be cleaned and the type of soil to be removed. In addition, concentrates are cost effective from the standpoint of shipping and warehousing. Finally, concentrates, when used full strength for spot cleaning, are effective for removing extremely difficult to remove soils and stains.

All purpose hard surface cleaning compositions are described in U.S. Pat. No. 3,453,144 to Morgan; U.S. Pat. No. 3,882,038 to Clayton et al; U.S. Pat. No. 3,709,825 to Chirash et al; U.S. Pat. No. 3,923,678 to Kleiner et al; U.S. Pat. No. 4,302,348 to Requejo; U.S. Pat. No. 4,152,305 to Berghausen, III; U.S. Pat. Nos. 3,956,161 and 3,966,628 to Woodward, U.S. Pat. No. 4,175,062 to Disch et al; U.S. Pat. No. 3,887,497 to Ulvild; U.S. Pat. No. 3,239,467 to Lipinski; U.S. Pat. No. 3,210,287 to Kelly et al, and U.S. Pat. No. 3,591,510 to Zenk.

There is a strong unmet consumer need to deliver freshness to the environment during and/or after hard surface cleaning processes. Because of the volatile nature of fragrance molecules and the effect of surfactant ingredients in the cleansers, achieving long lasting post-cleaning freshness by traditional technology is difficult.

Encapsulation of fragrance materials is well known in the art. Encapsulation provides advantages to the fragrance product including the protection of the fragrance in the capsule core by a shell until the fragrance is intended to be delivered. In particular, capsules are often designed to deliver their contents at a desired time by the capsule shell being compromised at the desired time.

The capsule shell can be compromised by various factors such as temperature so that the contents are delivered when the capsule begins to melt. Alternatively the capsules can be compromised by physical forces, such as crushing, or other methods that compromise the integrity of the capsule. Additionally, the capsule contents may be delivered via diffusion through the capsule wall during a desired time interval.

It is obviously not desired that the core be released from the shell prematurely. Often, the capsule shell is somewhat permeable to the core contents when stored under certain conditions. This is particularly the case when many capsule types, such as those having aminoplast or cross-linked gelatin walls, are stored in aqueous bases, particularly those containing surfactants. In these cases, although the capsule shell is intact, the fragrance is removed from the core over time in a leaching process. The overall leaching mechanism may be viewed as a diffusion process, with transfer occurring from the capsule core to the aqueous media, followed by transfer to or solubilization into the surfactant micelles or vesicles. With normal surfactant concentrations of between 4 and 30% in consumer products, as compared to fragrance levels of 0.3 to 1%, it is clear that the partitioning favors absorption by the surfactant over time.

Bases that are primarily non-aqueous in nature, e.g., those that are based on alcohols, or volatile silicones can also leach fragrance from capsules over time. In these product types, the base solvent itself solubilizes the fragrance.

U.S. Pat. No. 6,106,875 discloses a method of encapsulating an amphiphilic volatile flavor or fragrance compound into a microcapsule have a hydrogel shell and an oil core. The flavor or fragrance compound in a liquid is transported into and solubilized into the core using water in the capsule wall to transport the material. The patent discloses that this technique provides a wall thickness and a flavor or fragrance concentration not previously obtainable.

Despite the above teaching and previous encapsulation technologies, there is an ongoing need to develop fragrance systems and new cleaning compositions which are designed to retain the fragrance with minimal losses until it is needed and then be able to deliver the fragrance at the appropriate time.

### SUMMARY OF THE INVENTION

The present invention provides a hard surface cleaning composition comprising an admixture of a plurality of rupturable microcapsules each of which has (a) an outside diameter in the range of from about 0.01 to about 1000 microns; (b) a wall having a thickness in the range of from about 0.01 to about 100 microns; (c) a wall composed of a substituted or un-substituted acrylic acid polymer or co-polymer cross-linked with a melamine-formaldehyde pre-condensate or a urea-formaldehyde pre-condensate; and (d) a liquid phase monophasic core comprising a fragrance composition and/or a malodour counteractant composition, each of the components of which has a ClogP of from about 3.3 to about 8.0, the concentration of fragrance composition components and/or malodour counteractant composition components in the hard surface cleaning composition being in the range from about 0.01% to about 10% by weight of the hard surface cleaning composition, the range of weight percent of fragrance composition components and/or malodour counteractant composition in the plurality of microcapsules being from about 50% to about 97% by weight of filled microcapsules; and (ii) a hard surface cleaning base and optionally a thickener for maintaining in suspension said plurality of microcapsules.

In a further embodiment the encapsulated fragrance material may be coated with a cationic polymer.

In another embodiment, our invention provides a hard surface cleaning composition wherein each of the plurality of rupturable microcapsules has a wall composed of an unsubstituted acrylamide-acrylic acid copolymer having a molecular weight in the range of from 5,000 to 1,000,000 cross-linked with a melamine-formaldehyde pre-condensate, wherein the mole ratio of acrylic acid monomeric units:acrylamide monomeric units is from 9:1 to 1:9 and wherein the mole ratio of melamine-formaldehyde precondensate cross-linking agent:acrylamide-acrylic acid copolymer is in the range of from 9:1 to 1:9.

In another embodiment, our invention provides methods of making a hard surface cleaning product comprising encapsulated fragrance composition components and/or malodour counteractant composition components.

In yet another embodiment, articles of manufacture containing the hard surface cleaning composition of the present invention are provided.

These compositions appear to be especially well suited for use in cleaning toilet bowls, baths, shower surrounds and other plumbing fixtures, bathroom and kitchen hard surfaces, glass windows and floor surfaces.

### BRIEF DESCRIPTION OF THE DRAWINGS

FIG. 1 graphically represents the benefit of the hard surface cleaning composition versus commercially available spray hard surface cleaning compositions.

FIG. 2 graphically represents the sensory evaluation before and after the test floor panels were dry mopped over a fifty day period between the hard surface cleaning composition of the present invention containing capsule technology versus commercially available hard surface cleaners containing neat fragrance.

FIG. 3 graphically represents the sensory score between the neat fragrance and the capsule fragrance of the present invention.

FIG. 4 graphically represents the sensory score over time of the different treatment between the commercially available nonwoven mopping cloths general formulation+neat fragrance and the commercially available nonwoven mopping cloths general formulation+the capsule fragrance of the present invention.

### DETAILED DESCRIPTION OF THE INVENTION

The fragrances suitable for use in this invention include without limitation, any combination of fragrance, essential oil, plant extract or mixture thereof that is compatible with, and capable of being encapsulated by a polymer.

Many types of fragrances can be employed in the present invention, the only limitation being the compatibility and ability to be encapsulated by the polymer being employed, and comparability with the encapsulation process used. Suitable fragrances include but are not limited to fruits such as almond, apple, cherry, grape, pear, pineapple, orange, strawberry, raspberry; musk, flower scents such as lavender-like, rose-like, iris-like, and carnation-like. Other pleasant scents include herbal scents such as rosemary, thyme, and sage; and woodland scents derived from pine, spruce and other forest smells. Fragrances may also be derived from various oils, such as essential oils, or from plant materials such as peppermint, spearmint and the like. Other familiar and popular smells can also be employed such as baby powder, popcorn, pizza, cotton candy and the like in the present invention.

A list of suitable fragrances is provided in U.S. Pat. Nos. 4,534,891, 5,112,688 and 5,145,842, the contents of which are hereby incorporated by reference. Another source of suitable fragrances is found in Perfumes Cosmetics and Soaps, Second Edition, edited by W. A. Poucher, 1959. Among the fragrances provided in this treatise are acacia, cassie, chypre, cylamen, fern, gardenia, hawthorn, heliotrope, honeysuckle, hyacinth, jasmine, lilac, lily, magnolia, mimosa, narcissus, freshly-cut hay, orange blossom, orchids, reseda, sweet pea, trefle, tuberose, vanilla, violet, wallflower, and the like.

As disclosed in commonly assigned U.S. application Ser. No. 10/983,142, which is incorporated by reference as if set forth herein in their entirety, the logP of many perfume ingredients has been reported, for example, the Ponoma92 database, available from Daylight Chemical Information Systems, Inc. (Daylight CIS) Irvine, Calif. The values are most conveniently calculated using ClogP program also available from Daylight CIS. The program also lists experimentally determined logP values when available from the Pomona database. The calculated logP (ClogP) is normally determined by the fragment approach on Hansch and Leo (A. Leo, in Comprehensive Medicinal Chemistry, Vol. 4, C. Hansch, P. G. Sammens, J. B. Taylor and C. A. Ransden, Editiors, p. 295 Pergamon Press, 1990). This approach is based upon the chemical structure of the fragrance ingredient and takes into account the numbers and types of atoms, the atom connectivity and chemical bonding. The ClogP values which are most reliable and widely used estimates for this physiochemical property can be used instead of the experimental LogP values useful in the present invention. Further information regarding ClogP and logP values can be found in U.S. Pat. No. 5,500,138.

Fragrance materials with lower logP or ClogP, these terms will be used interchangeably from this point forward, exhibit higher aqueous solubility. Thus, when these materials are in the core of a capsule which is placed in an aqueous system, they will have a greater tendency to diffuse into the base if the shell wall is permeable to the fragrance materials. Without wishing to be bound by theory, it is believed that normally the mechanism of leaching from the capsule proceeds in three steps in an aqueous base. First, fragrance dissolves into the water that hydrates the shell wall. Second, the dissolved fragrance diffuses through the shell wall into the bulk water phase. Third, the fragrance in the water phase is absorbed by the hydrophobic portions of the surfactant dispersed in the base, thus allowing leaching to continue.

This situation may be improved by one embodiment of the present invention which involves the use of a vast preponderance of high ClogP fragrance materials. In this embodiment of the invention greater than about 60 weight percent of the fragrance materials have a ClogP of greater than 3.3. In another highly preferred embodiment of the invention more than 80 weight percent of the fragrances have a ClogP value of greater than about 4.0. Use of fragrance materials as described previously reduces the diffusion of fragrance through the capsule wall and into the base under specific time, temperature, and concentration conditions.

The following fragrance ingredients provided in Table 1 are among those suitable for inclusion within the capsule of the present invention:

TABLE 1

| PERFUME INGREDIENTS | CLOGP |
|---|---|
| Allyl cyclohexane propionate | 3.935 |
| Ambrettolide | 6.261 |
| Amyl benzoate | 3.417 |
| Amyl cinnamate | 3.771 |
| Amyl cinnamic aldehyde | 4.324 |
| Amyl cinnamic aldehyde dimethyl acetal | 4.033 |
| Iso-amyl salicylate | 4.601 |
| Aurantiol (Trade name for Hydroxycitronellal- | 4.216 |
| methylanthranilate) | |
| Benzyl salicylate | 4.383 |
| para-tert-Butyl cyclohexyl acetate | 4.019 |
| Iso butyl quinoline | 4.193 |
| beta-Caryophyllene | 6.333 |
| Cadinene | 7.346 |
| Cedrol | 4.530 |
| Cedryl acetate | 5.436 |
| Cedryl formate | 5.070 |
| Cinnamyl cinnamate | 5.480 |
| Cyclohexyl salicylate | 5.265 |
| Cyclamen aldehyde | 3.680 |
| Diphenyl methane | 4.059 |
| Diphenyl oxide | 4.240 |
| Dodecalactone | 4.359 |
| Iso E Super (Trade name for 1-(1,2,3,4,5,6,7,8- | 3.455 |
| Octahydro-2,3,8,8-tetramethyl-2-naphthalenyl)- | |
| ethanone) | |
| Ethylene brassylate | 4.554 |
| Ethyl undecylenate | 4.888 |
| Exaltolide (Trade name for 15-Hydroxyentadecanloic | 5.346 |
| acid, lactone) | |
| Galaxolide (Trade name for 1,3,4,6,7,8-Hexahydro- | 5.482 |
| 4,6,6,7,8,8-hexamethylcyclopenta-gamma-2- | |
| benzopyran) | |
| Geranyl anthranilate | 4.216 |
| Geranyl phenyl acetate | 5.233 |
| Hexadecanolide | 6.805 |
| Hexenyl salicylate | 4.716 |
| Hexyl cinnamic aldehyde | 5.473 |
| Hexyl salicylate | 5.260 |
| Alpha-Irone | 3.820 |
| Lilial (Trade name for para-tertiary-Butyl-alpha- | 3.858 |
| methyl hydrocinnamic aldehyde) | |
| Linalyl benzoate | 5.233 |
| Methyl dihydro jasmone | 4.843 |
| Gamma-n-Methyl ionone | 4.309 |
| Musk indanone | 5.458 |
| Musk tibetine | 3.831 |
| Oxahexadecanolide-10 | 4.336 |
| Oxahexadecanolide-11 | 4.336 |
| Patchouli alcohol | 4.530 |
| Phantolide (Trade name for 5-Acetyl-1,1,2,3,3,6- | 5.977 |
| hexamethyl indan) | |
| Phenyl ethyl benzoate | 4.058 |
| Phenylethylphenylacetate | 3.767 |
| Phenyl heptanol | 3.478 |
| Alpha-Santalol | 3.800 |
| Thibetolide (Trade name for 15- | 6.246 |
| Hydroxypentadecanoic acid, lactone) | |
| Delta-Undecalactone | 3.830 |
| Gamma-Undecalactone | 4.140 |
| Vetiveryl acetate | 4.882 |
| Ylangene | 6.268 |

The performance of the capsules of the present invention may be improved through the use of a vast preponderance of high ClogP fragrance materials. In this embodiment of the invention greater than about 60 weight percent of the fragrance materials have a ClogP of greater than 3.3. In another highly preferred embodiment of the invention more than 80 weight percent of the fragrances have a ClogP value of greater than about 4.0. Use of fragrance materials as described previously reduces the diffusion of fragrance through the capsule wall and into the base under specific time, temperature, and concentration conditions.

The higher ClogP materials are preferred, meaning that those materials with a ClogP value of 4.5 are preferred over those fragrance materials with a ClogP of 4; and those materials are preferred over the fragrance materials with a ClogP of 3.3.

The fragrance formulation of the present invention should have at least about 60 weight percent of materials with ClogP greater than 3.3, preferably greater than about 80 and more preferably greater than about 90 weight percent of materials with ClogP greater than 4.

Those with skill in the art appreciate that fragrance formulations are frequently complex mixtures of many fragrance ingredients. A perfumer commonly has several thousand fragrance chemicals to work from. Those with skill in the art appreciate that the present invention may contain a single ingredient, but it is much more likely that the present invention will comprise at least eight or more fragrance chemicals, more likely to contain twelve or more and often twenty or more fragrance chemicals. The present invention also contemplates the use of complex fragrance formulations containing fifty or more fragrance chemicals, seventy five or more or even a hundred or more fragrance chemicals in a fragrance formulation.

Preferred fragrance materials will have both high ClogP and high vapor pressure. Among those having these properties are: Para cymene, Caphene, Mandarinal Firm, Vivaldie, Terpinene, Verdox, Fenchyl acetate, Cyclohexyl isovalerate, Manzanate, Myrcene, Herbavert, Isobutyl isobutyrate, Tetrahydrocitral, Ocimene and Caryophyllene.

As used herein olfactory effective amount is understood to mean the amount of compound in perfume compositions the individual component will contribute to its particular olfactory characteristics, but the olfactory effect of the fragrance composition will be the sum of the effects of each of the fragrance ingredients. Thus the compounds of the invention can be used to alter the aroma characteristics of the perfume composition by modifying the olfactory reaction contributed by another ingredient in the composition. The amount will vary depending on many factors including other ingredients, their relative amounts and the effect that is desired.

The level of fragrance in the encapsulated fragrance varies from about 5 to about 95 weight percent, preferably from about 40 to about 95 and most preferably from about 50 to about 90 weight percent on a dry basis. In addition to the fragrance other agents can be used in conjunction with the fragrance and are understood to be included.

Specific examples of malodour counteractant composition components useful in the aminoplast microencapsulates used in the composition and process of our invention are as follows:

Malodour Counteractant Component Group I:

1-cyclohexylethan-1-yl butyrate;
1-cyclohexylethan-1-yl acetate;
1-cyclohexylethan-1-ol;
1-(4′-methylethyl)cyclohexylethan-1-yl propionate; and
2′-hydroxy-1′-ethyl(2-phenoxy)acetate
   each of which compound is marketed under the trademark VEILEX by International Flavors & Fragrances Inc., New York, N.Y., U.S.A.
   Malodour Counteractant Component Group II, as Disclosed in U.S. Pat. No. 6,379,658:
β-naphthyl methyl ether;
β-naphthyl ketone;
benzyl acetone;
mixture of hexahydro-4,7-methanoinden-5-yl propionate and hexahydro-4,7-methanoinden-6-yl propionate;
4-(2,6,6-trimethyl-2-cyclohexen-1-yl)-3-methyl-3-buten-2-one;
3,7-dimethyl-2,6-nonadien-1-nitrile;
dodecahydro-3a,6,6,9a-tetramethylnaphtho(2,1-b)furan;
ethylene glycol cyclic ester of n-dodecanedioic acid;
1-cyclohexadecen-6-one;
1-cycloheptadecen-10-one; and
corn mint oil.

In addition to the fragrance materials and/or malodour counteractant materials that are to be encapsulated in the present invention, the present invention also contemplates the incorporation of solvent materials. The solvent materials are hydrophobic materials that are miscible in the fragrance materials used in the present invention. Suitable solvents are those having reasonable affinity for the fragrance chemicals and a ClogP greater than 3.3, preferably greater than 8 and most preferably greater that 10. Suitable materials include, but are not limited to triglyceride oil, mono and diglycerides, mineral oil, silicone oil, diethyl phthalate, polyalpa olefins, castor oil and isopropyl myristate. In a preferred embodiment the solvent materials are combined with fragrance materials that have high ClogP values as set forth above. It should be noted that selecting a solvent and fragrance with high affinity for each other will result in the most pronounced improvement in stability. Appropriate solvents may be selected from the following non-limiting list:
Mono-, di- and tri-esters, and mixtures thereof, of fatty acids and glycerine. The fatty acid chain can range from C4-C26. Also, the fatty acid chain can have any level of unsaturation. For instance capric/caprylic triglyceride known as Neobee M5, available Stepan Corporation. Other suitable examples are the Capmul series by Abitec Corporation. For instance, Capmul MCM.
Isopropyl myristate
Fatty acid esters of polyglycerol oligomers:
   R2CO—[OCH2-CH(OCOR1)-CH2O-]n, where R1 and R2 can be H or C4-26 aliphatic chains, or mixtures thereof, and n ranges between 2-50, preferably 2-30.
Nonionic fatty alcohol alkoxylates like the Neodol surfactants by BASF, the Dobanol surfactants by Shell Corporation or the BioSoft surfactants by Stepan. The alkoxy group being ethoxy, propoxy, butoxy, or mixtures thereof. In addition, these surfactants can be end-capped with methyl groups in order to increase their hydrophobicity.
Di- and tri-fatty acid chain containing nonionic, anionic and cationic surfactants, and mixtures thereof.
Fatty acid esters of polyethylene glycol, polypropylene glycol, and polybutylene glycol, or mixtures thereof.
Polyalphaolefins such as the ExxonMobil PureSym™ PAO line
Esters such as the ExxonMobil PureSyn™ Esters
Mineral oil
Silicone oils such polydimethyl siloxane and polydimethylcyclosiloxane
Diethyl phthalate
Di-isodecyl adipate

The level of solvent in the core of the encapsulated fragrance material should be greater than about 30 weight percent, preferably greater than about 50 weight percent and most preferably greater than about 75 weight percent. In addition to the solvent it is preferred that higher ClogP fragrance materials are employed. It is preferred that greater than about 25 weight percent, preferably greater than 30 and more preferably greater than about 40 weight percent of the fragrance chemicals have ClogP values of greater than about 2.5, preferably greater than about 3 and most preferably greater than about 3.5. Those with skill in the art will appreciate that many formulations can be created employing various solvents and fragrance chemicals. The use of high ClogP fragrance chemicals will require a lower level of hydrophobic solvent than fragrance chemicals with lower ClogP to achieve similar stability. As those with skill in the art will appreciate, in a highly preferred embodiment high ClogP fragrance chemicals and hydrophobic solvents comprise greater than about 80, preferably more than about 90 and most preferably greater than 99 weight percent of the fragrance composition.

It has also been found that the addition of hydrophobic polymers to the core can also improve stability by slowing diffusion of the fragrance from the core. The level of polymer is normally less than 80% of the core by weight, preferably less than 50%, and most preferably less than 20%. The basic requirement for the polymer is that it be miscible or compatible with the other components of the core, namely the fragrance and other solvent. Preferably, the polymer also thickens or gels the core, thus further reducing diffusion. Polymers may be selected from the non-limiting group below:
Copolymers of ethylene. Copolymers of ethylene and vinyl acetate (Elvax polymers by DOW Corporation). Copolymers of ethylene and vinyl alcohol (EVAL polymers by Kuraray). Ethylene/Acrylic elastomers such as Vamac polymers by Dupont).
Poly vinyl polymers, such as poly vinyl acetate.
Alkyl-substituted cellulose, such as ethyl cellulose (Ethocel made by DOW Corporation), hydroxypropyl celluloses (Klucel polymers by Hercules)
Uncharged polyacrylates. Examples being (i) Amphomer, Demacryl LT and Dermacryl 79, made by National Starch and Chemical Company, (ii) the Amerhold polymers by Amerchol Corporation, and (iii) Acudyne 258 by ISP Corporation.
Copolymers of acrylic or methacrylic acid and fatty esters of acrylic or methacrylic acid. These are side-chain crystallizing. Typical polymers of this type are those listed in U.S. Pat. Nos. 4,830,855, 5,665,822, 5,783,302, 6,255,367 and 6,492,462. Examples of such polymers are the Intelimer Polymers, made by Landec Corporation.
Polypropylene oxide.
Polybutylene oxide of poly(tetra hydrofuran).
Polyethylene terephthalate.
Alkyl esters of poly(methyl vinyl ether)—maleic anhydride copolymers, such as the Gantrez copolymers and Omnirez 2000 by ISP Corporation.
Carboxylic acid esters of polyamines. Examples of this are ester-terminated polyamide (ETPA) made by Arizona Chemical Company.
Poly vinyl pyrrolidone (Luviskol series of BASF).
Block copolymers of ethylene oxide, propylene oxide and/or butylenes oxide. These are known as the Pluronic and Synperonic polymers/dispersants by BASF.
Another class of polymers include polyethylene oxide-co-propyleneoxide-co-butylene oxide polymers of any ethylene oxide/propylene oxide/butylene oxide ratio with cationic groups resulting in a net theoretical positive charge or equal to zero (amphoteric). The general structure is:

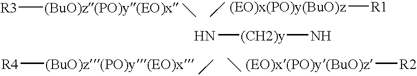

where R1, R2, R3, R4 is H or any alkyl of fatty alkyl chain group. Examples of such polymers are the commercially known as Tetronics by BASF Corporation.

We have also discovered that when capsules having cores containing a very large proportion of solvents with the appropriate ClogP values and/or with the high ClogP fragrance chemicals described above the encapsulated materials are actually capable of absorbing fragrance chemicals from surfactant-containing product bases. As is well appreciated by those with skill in the art, products such as, but not limited to hard surface cleaners like floor cleaners and glass cleaners contain in their base formulas functional materials such as surfactants, emulsifying agents, solvents and the like along with fragrance chemicals. These products often aggressively absorb fragrance ingredients, most often due to the partially hydrophobic surfactant.

Most consumer products are made using an aqueous base, although some products use silicone or polyurethane as the significant solvent or carrier. Absorption from these bases is also possible if the core is properly designed and used at the appropriate level in the base. Examples of these products include furniture cleaners such as PLEDGE, registered trademark of SC JOHNSON.

In the product base the fragrance is used to provide the consumer with a pleasurable fragrance during and after using the product or to mask unpleasant odors from some of the functional ingredients used in the product. As stated above, one long standing problem with the use of fragrance in product bases is the loss of the fragrance before the optimal time for fragrance delivery. We have discovered that with the proper selection of solvent and/or fragrance chemicals in the capsule core, the capsule will successfully compete for the fragrance chemicals present in the aqueous product base during storage. Eventually the core absorbs a significant quantity of fragrance, and finally an equilibrium level of fragrance is established in the core which is specific to the starting core composition and concentration in the base, type and concentration of the fragrance materials in the base, base composition, and conditions of storage. This ability to load the capsule core with fragrance material from the product base, particularly those product bases that contain a high concentration of surfactant proves that with judicious selection of core composition good fragrance stability within the core can be achieved.

Therefore, in another embodiment of the present invention is a method for providing encapsulated fragrance products through the re-equilibration of the fragrance materials from the product base into the capsules. The process includes providing a product base containing fragrance materials and capsules with a permeable shell, the capsules containing a solvent as defined above or with high ClogP fragrance materials. The solvents and high ClogP fragrance materials have an affinity for the fragrance material. In order to absorb fragrance materials that previously are not present in the core of the capsules, to re-equilibrate into the capsule core it is preferred that the capsules contain some void space or contain some lower ClogP fragrance materials that can partition out of the capsule into product base. Capsule shells with the appropriate degree of permeability are described in the application.

As described above capsules loaded with solvent and or high ClogP fragrance materials will absorb other fragrance materials from the product. In this embodiment of the invention, the capsule cores compete with the surfactant and primarily aqueous media of the products for fragrance materials placed in the product bases during storage. Eventually the cores absorb a significant quantity of fragrance, and finally an equilibrium level of fragrance is established in the core which is specific to a given starting core composition and concentration in the base, type and concentration of fragrance materials in the base, base compositions and conditions of storage. The self-loading of the cores in bases that have high concentrations of surfactants also indicates that by judicious core selection fragrance stability within the core can be achieved.

As used herein stability of the products is measured at room temperature or above over a period of at least a week. More preferably the capsules of the present invention are allowed to be stored at room temperature for more than about two weeks and preferably more than about a month.

More specifically, the present invention provides a method of providing a hard surface cleaning composition comprising:

providing a product base containing non-encapsulated fragrance material and/or malodour counteractant material and surfactant material;

providing a permeable capsule wherein the permeable capsule contains greater than about 60 weight percent fragrance material and/or malodour counteractant material having a ClogP value of greater than about 3.3 or suitable hydrophobic solvent; and

allowing the non-encapsulated fragrance material and/or malodour counteractant material and the permeable capsule material containing the fragrance material to come to equilibrium thereby transporting the non-encapsulated fragrance and/or malodour counteractant material through the permeable shell wall into the interior of the capsule and retaining the fragrance and/or malodour counteractant contents of the permeable capsule; and

admixing with a hard surface cleaning base to provide a hard surface cleaning composition.

In this embodiment of the invention a method for providing a hard surface cleaning composition with an increased amount of a fragrance and/or malodour counteractant material within a capsule comprising an aqueous base product that contains surfactant and fragrance, providing a capsule permeable to the fragrance and/or malodour counteractant material when stored in the base, contained within said capsule greater than about 60 weight percent components selected from the group consisting of water insoluble solvent and fragrance and/or malodour counteractant material chemicals having a ClogP value of greater than about 3.3; storing the aqueous product base and the porous capsule for at least about a week, thereby allowing the fragrance and/or malodour counteractant material chemicals provided in the aqueous base to be transported through the capsule wall and then finally admixing the capsule with a hard surface cleaning base to provide the hard surface cleaning composition.

As further described, the selection of solvents and fragrance and/or malodour counteractant material chemicals with correct ClogP values results in capsules with higher fragrance loading. The higher fragrance loading results in higher fragrance delivery than what was previously possible with fragrance provided in the aqueous base or provided in an oil included in the base. For example, when the capsules are employed in a hard surface cleaning product it was discovered that the capsules of the present invention deposited fragrance as measured by the breaking of the capsules and the measurement of fragrance in the headspace to be more than 100% greater than fragrance alone or fragrance and solvent combinations deposited on the same hard surface. In some instances the headspace measurement indicated an increase of more than 1000% and even greater than about 2000% when measuring fragrance in the headspace when employing the capsules with high ClogP materials and/or suitable solvents when compared to fragrance or fragrance solvent combinations.

In another embodiment of the present invention a sacrificial solvent is initially placed with the capsule. A sacrificial solvent is a solvent having a low ClogP value of from about 1 to about 3, preferably from about 1.25 to about 2.5, and most preferably from about 1.5 to about 2. If the ClogP of the sacrificial solvent is too low, the sacrificial solvents will be lost in the manufacture of the capsule materials. Suitable sacrificial solvents include benzyl acetate, and octanol.

The present invention also provides a method of making a hard surface cleaning composition comprising capsules containing high Clog P liquid fragrance and/or malodour counteractant material materials within the capsule comprising the steps of:

providing a sacrificial solvent having a ClogP value of from about 1 to about 3;

encapsulating the sacrificial solvent with a permeable encapsulate material;

providing the encapsulated sacrificial solvent in a liquid environment containing fragrance materials with ClogP of greater than about 3.3;

allowing the capsules containing the sacrificial solvent to come to equilibrium with the environment containing the high Clog P fragrance materials;

whereby at least 20 weight percent of the sacrificial solvent migrates from the capsule into the environment; and

admixing the encapsulated fragrance and/or malodour counteractant material and/or solvent and external non-encapsulated fragrance with a hard surface cleaning base to provide a hard surface cleaning composition.

Preferably more than 30 and more than 40 weight percent of the sacrificial solvent will migrate from the capsules to the environment, thereby allowing the capsules to increase the level of high ClogP fragrance and/or malodour counteractant material material inside the capsule by more than 10 weight percent, preferably more than 20 and most preferably more than 30 weight percent over the original weight of ClogP materials above 3.3 originally found inside the capsule.

The time for this migration of the sacrificial solvent from the interior of the permeable capsule to the environment, thereby creating space within the capsule for the high ClogP materials to migrate into the capsule is as short as seven to ten days. This means that under normal product manufacture, shipping and distribution, the sacrificial solvent will have sufficient time to migrate from the capsule interior, thereby creating free volume and allowing the preferred higher ClogP materials to migrate into the interior. Of course, longer periods of time will allow greater amounts of the sacrificial solvent to exit through the capsule wall and create more free volume and eventually a true equilibrium will occur where at a given temperature, the migration of sacrificial solvent out of the capsule and migration of high ClogP material into the capsule will eventually end.

An important advantage of the migration technology is that capsules containing sacrificial solvent can be prepared in large quantities, and placed in various fragrance environments. This means that through the proper selection of fragrance materials and/or malodour counteractant material, capsules and sacrificial solvent, an encapsulated fragrance materials can be prepared without having to encapsulate each specific custom fragrance.

The invention in its various embodiments provides a capsule core composition that is able to retain a significant amount of fragrance and/or malodour counteractant material within the capsule core and to deliver the higher level of fragrance contained therein at the desired time. We have discovered that the capsule products of the present invention under specified times of time, temperature, and concentration in various product bases retain more than about 10 weight percent, preferably more than 30 and most preferably more than 70 weight percent of the fragrance and/or malodour counteractant materials originally encapsulated.

Fragrance retention within the capsule may be measured directly after storage at a desired temperature and time periods such as six weeks, two months, three months or more. The preferred manner is to measure total headspace of the product at the specified time and to compare the results to the headspace of a control product made to represent 100% retention via direct addition of the total amount of fragrance present.

Alternatively, the product base may be performance tested after the storage period and the performance compared to the fresh product, either analytically or by sensory evaluation. This more indirect measurement often involves either measuring the fragrance headspace over a substrate used with the product, or odor evaluation of the same substrate.

A common feature of many encapsulation processes is that they require the fragrance material and/or malodour counteractant material to be encapsulated to be dispersed in aqueous solutions of polymers, pre-condensates, surfactants, and the like prior to formation of the capsule walls. Therefore, materials having low solubility in water, such as highly hydrophobic materials are preferred, as they will tend to remain in the dispersed perfume phase and partition only slightly into the aqueous solution. Fragrance materials with Clog P values greater than 1, preferably greater than 3, and most preferably greater than 5 will thus result in micro-capsules that contain cores most similar to the original composition, and will have less possibility of reacting with materials that form the capsule shell.

One object of the present invention is to deposit capsules containing fragrance and/or malodour counteractant cores on desired substrates such as toilet bowls, baths, shower surrounds and other plumbing fixtures, bathroom and kitchen hard surfaces, glass windows, floor surfaces and other hard surfaces.

Further, it is desired that, once deposited, the capsules release the encapsulated fragrance and/or malodour counteractant material either by walking, wiping, dry-mopping or sweeping the hard surface or by diffusion through the capsule wall, via small cracks or imperfections in the capsule wall caused by drying, physical, or mechanical means, or by large-scale rupture of the capsule wall. In each of these cases, the volatility of the encapsulated perfume materials is critical to both the speed and duration of release, which in turn control consumer perception. Thus, fragrance chemicals which have higher volatility as evidenced by normal boiling points of less than 250° C., preferably less than about 225° C. are preferred in cases where quick release and impact of fragrance is desired. Conversely, fragrance chemicals that have lower volatility (boiling points greater than 225° C.) are preferred when a longer duration of aroma is desired. Of course, fragrance chemicals having varying volatility may be combined in any proportions to achieve the desired speed and duration of perception.

In order to provide the highest fragrance impact from the fragrance encapsulated capsules deposited on the various substrates referenced above, it is preferred that materials with a high odor-activity be used. Materials with high odor-activity can be detected by sensory receptors at low concentrations in air, thus providing high fragrance perception from low levels of deposited capsules. This property must be balanced with the volatility as described above. Some of the principles mentioned above are disclosed in U.S. Pat. No. 5,112,688.

Further, it is clear that materials other than fragrances may be employed in the system described here. Examples of other materials which may be usefully deposited from rinse-off products using the invention include sunscreens, softening agents, insect repellents, and fabric conditioners, among others.

Encapsulation of fragrances is known in the art, see for example U.S. Pat. Nos. 2,800,457, 3,870,542, 3,516,941, 3,415,758, 3,041,288, 5,112,688, 6,329,057, and 6,261,483, all of which are incorporated by reference as if set forth in their entirety. Another discussion of fragrance encapsulation is found in the Kirk-Othmer Encyclopedia.

Preferred encapsulating polymers include those formed from melamine-formaldehyde or urea-formaldehyde condensates, as well as similar types of aminoplasts. Additionally, capsules made via the simple or complex coacervation of gelatin are also preferred for use with the coating. Capsules having shell walls comprised of polyurethane, polyamide, polyolefin, polysaccaharide, protein, silicone, lipid, modified cellulose, gums, polyacrylate, polyphosphate, polystyrene, and polyesters or combinations of these materials are also functional.

A representative process used for aminoplast encapsulation is disclosed in U.S. Pat. No. 3,516,941 though it is recognized that many variations with regard to materials and process steps are possible. A representative process used for gelatin encapsulation is disclosed in U.S. Pat. No. 2,800,457 though it is recognized that many variations with regard to materials and process steps are possible. Both of these processes are discussed in the context of fragrance encapsulation for use in consumer products in U.S. Pat. Nos. 4,145,184 and 5,112,688 respectively.

The urea-formaldehyde and melamine-formaldehyde pre-condensate microcapsule shell wall precursors are prepared by means of reacting urea or melamine with formaldehyde where the mole ratio of melamine or urea to formaldehyde is in the range of from about 10:1 to about 1:6, preferably from about 1:2 to about 1:5. For purposes of practicing our invention, the resulting material has a molecular weight in the range of from 156 to 3000. The resulting material may be used ‘as-is’ as a cross-linking agent for the aforementioned substituted or un-substituted acrylic acid polymer or copolymer or it may be further reacted with a C₁-C₆ alkanol, e.g., methanol, ethanol, 2-propanol, 3-propanol, 1-butanol, 1-pentanol or 1-hexanol, thereby forming a partial ether where the mole ratio of melamine or urea:formalhyde:alkanol is in the range of 1:(0.1-6):(0.1-6). The resulting ether moiety-containing product may by used ‘as-is’ as a cross-linking agent for the aforementioned substituted or un-substituted acrylic acid polymer or copolymer, or it may be self-condensed to form dimers, trimers and/or tetramers which may also be used as cross-linking agents for the aforementioned substituted or un-substituted acrylic acid polymers or co-polymers. Methods for formation of such melamine-formaldehyde and urea-formaldehyde pre-condensates are set forth in U.S. Pat. No. 3,516,846, U.S. Pat. No. 6,261,483, and Lee et al. J. Microencapsulation, 2002, Vol. 19, No. 5, pp 559-569, “Microencapsulation of fragrant oil via in situ polymerization: effects of pH and melamine-formaldehyde molar ratio”. Examples of urea-formaldehyde pre-condensates useful in the practice of our invention are URAC 180 and URAC 186, Cytec Technology Corp. Examples of melamine-formaldehyde pre-condensates useful in the practice of our invention are CYMEL U-60, CYMEL U-64 and CYMEL U-65 manufactured by Cytec Technology Corp.

In the practice of our invention it is preferable to use as the precondensate for cross-linking the substituted or un-substituted acrylic acid polymer or co-polymer the melamine-formaldehyde pre-condensate having the structure: 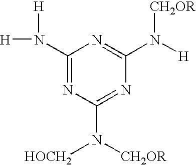
wherein each of the R groups are the same or different and each represents hydrogen or C₁-C₆ lower alkyl, e.g. methyl, ethyl, 1-propyl, 2-propyl, 1-butyl, 2-butyl, 2-methyl-1-propyl, 1-pentyl, 1-hexyl and/or 3-methyl-1-pentyl.

In practicing our invention, the range of mole ratios of urea-formaldehyde precondensate or melamine-formaldehyde pre-condensate: substituted or un-substituted acrylic acid polymer or co-polymer is in the range of from about 9:1 to about 1:9, preferably from about 5:1 to about 1:5 and most preferably from about 1:2 to about 2:1.

The average outside diameter of the resulting microcapsule is in the range of from about 0.01 microns to about 1000 microns; preferably from about 0.05 microns to about 100 microns and more preferably from about 2.0 microns to about 20 microns. The average wall thickness of the resulting microcapsule is in the range of from about 0.01 microns to about 100 microns; preferably from about 0.05 microns to about 10 microns and more preferably from about 0.2 microns to about 2.0 microns.

The content of the resulting microcapsule includes a fragrance composition and/or a malodour counteractant composition in combination with a compatible hydrophobic solvent. The term “compatible” is herein intended to mean chemically non-reactive with every fragrance component and/or malodour counteractant component and capable of forming a single liquid phase with each fragrance composition component and with each malodour composition component. In the practice of our invention, the range of weight percent of solvent/fragrance composition components and/or solvent/malodour counteractant composition components contained in each of the microcapsules is from about 50% to about 97% by weight of the microcapsule, preferably from about 91% to about 96%. Thus, the range of weight ratios of encapsulating polymer to solvent/fragrance composition components and/or solvent/malodour counteractant components is from about 1:25 to about 1:1; preferably from about 1:10 to about 4:96. In addition, the range of weight percent of solvent in the microcapsule is from about 10% to 80% by weight of the filled microcapsule. The preferred ratio of weight of solvent: weight of encapsulated fragrance composition and/or encapsulated malodour counteractant composition is from about 2:1 to about 1:2, with the most preferred ratio being about 1:1.

Well known materials such as solvents, surfactants, emulsifiers, and the like can be used in addition to the polymers described above to encapsulate the fragrance without departing from the scope of the present invention. It is understood that the term encapsulated is meant to mean that the fragrance material is substantially covered in its entirety. Encapsulation can provide pore vacancies or interstitial openings depending on the encapsulation techniques employed. More preferably the entire fragrance material portion of the present invention is encapsulated.

Rheology modifiers should be selected carefully to insure compatibility with the deposition agents. Examples are nonionic, cationic and amphoteric thickeners, such as modified polysaccharides (starch, guar, celluloses, xanthan), polyethylene imine (Lupasol WF, BASF Corporation), acrylates (Structure Plus, National Starch and Chemical Company) and cationic silicones. Preferred thickeners for maintaining in the plurality of microcapsules in suspension in the hard surface cleaning composition are gums, in particular xanthan gum, added at a concentration of from about 0.1% to about 3%.

Particles comprised of fragrance and a variety of polymeric and non-polymeric matrixing materials are also suitable for use. These may be composed of polymers such as polyethylene, fats, waxes, or a variety of other suitable materials. Essentially any capsule, particle, or dispersed droplet may be used that is reasonably stable in the application and release of fragrance at an appropriate time once deposited.

Particle and capsule diameter can vary from about 0.01 nanometers to about 1000 microns, preferably from about 0.01 nanometers to about 100 microns. The capsule distribution can be narrow, broad, or multi-modal. Multi-modal distributions may be composed of different types of capsule chemistries.

The compatible hydrophobic solvent used in combination with the microencapsulated fragrance composition and/or microencapsulated malodour counteractant composition is preferably a mono-, di- or tri-C₄-C₂₆ saturated or unsaturated fatty acid glyceride, diethyl phthalate, dibutyl phthalate, diisodecyl adipate, a liquid polydimethyl siloxane, a liquid polydimethylcyclosiloxane, the methyl ester of soya fatty acid, a mixture of soya fatty acid methyl ester and isopropyl myristate with the weight ratio of soya fatty acid:isopropyl myristate being from 2:1 to 20:1 and a mineral oil compatible with each component of said fragrance composition and/or said malodour counteractant composition. More preferably, the solvent is a tri-C₄-C₂₆ saturated or unsaturated fatty acid glyceride. Most preferably, the solvent is the tri-glyceride ester of a mixture of caprylic acid and capric acid, commercially available as NEOBEE M-5, trademark of the Stepan Chemical Company of Northfield, Ill., U.S.A. The C log₁₀P′ of the solvent is greater than 3.3, where P′ is the n-octanol/water partition coefficient of the hydrophobic solvent; preferably greater than about 8 and most preferably greater than about 10.

The C log₁₀P of each component of the encapsulated fragrance composition and/or the encapsulated malodour counteractant composition is in the range of from about 3.3 to about 8, where P is the n-octanol/water partition coefficient of the fragrance component.

In the preferred embodiment of the present invention the microcapsules containing encapsulated fragrances can be used in hard surface cleaning compositions. The hard surface cleaning products that are advantageously used with the polymer encapsulated fragrance and/or malodour counteractant of the present invention include all purpose cleaners, nonwoven mopping clothes and the like. These may be liquids, solids, pastes, or gels, of any physical form.

While the preferred coating materials may be simply dissolved in water and mixed with a suspension of capsules prior to addition to the final product, other modes of coating use and application are also possible. These modes include drying the coating solution in combination with the capsule suspension for use in dry products such as detergents, or using higher concentrations of coating such that a gel structure is formed, or combining the coating material with other polymers or adjuvants which serve to improve physical characteristics or base compatibility. Drying or reducing the water content of the capsule suspension prior to coating addition is also possible, and may be preferable when using some coating materials. Further, when using some coating materials it is possible to add the coating to the application base separately from the encapsulated fragrance and/or malodour counteractant.

Solvents or co-solvents other than water may also be employed with the coating materials. Solvents that can be employed here are (i) polyols, such as ethylene glycol, propylene glycol, glycerol, and the like, (ii) highly polar organic solvents such as pyrrolidine, acetamide, ethylene diamine, piperazine, and the like, (iii) humectants/plasticizers for polar polymers such as monosaccharides (glucose, sucrose, etc.), amino acids, ureas and hydroxyethyl modified ureas, and the like, (iv) plasticizers for less polar polymers, such as diisodecyl adipate (DIDA), phthalate esters, and the like.

Optionally, in order to provide an increased period of time during which the microencapsulates are retained on the treated hard surface, the aminoplast microencapsulates used in the practice of our invention may be coated with a cationic polymer as disclosed in Application for U.S. Letters patent Ser. No. 10/718,240 filed on Nov. 20, 2003 and, in addition, applications for patent, US 2004-00717421 A1 and US 2004-0072719 A1. The rate of use of such cationic polymer coatings on the microencapsulates is from about 1% to about 3000% by weight of the filled microencapsulates; preferably from about 5% to about 1000% by weight of the filled microencapsulates; and most preferably from about 10% to about 500% by weight of the filed microencapsulates.

Examples of such cationic polymers used as coatings are cationically modified starch and cationically modified guar, polymers comprising poly diallyl dimethyl ammonium halides (PolyDADMAC), and copolymers of DADMAC with vinyl pyrrolidone, acrylamides, imidazoles, imidazolinium halides, and the like. For instance, Polyquaternium-6, 7, 22 and 39, all available from Ondeo Nalco.

The preferred cationic starch has a molecular weight of from about 100,000 to about 500,000,000, preferably from about 200,000 to about 10,000,000 and most preferably from about 250,000 to about 5,000,000. The preferred cationic starch products are HI-CAT CWS42 and HI-CAT 02 and are commercially available from ROQUETTE AMERICA, Inc.

The preferred cationic guar has a molecular weight of from about 50,000 to about 5,000,000. The preferred cationic guar products are Jaguar C-162 and Jaguar C-17 and are commercially available from Rhodia Inc.

Additional examples of cationic polymers useful for coating the aminoplast encapsulated solvent/fragrance compositions and/or solvent/malodour counteractant compositions of our invention are the water-soluble cationic amino resins, cationic urea resins, specifically, urea-formaldehyde pre-polymers subjected to polycondensation with a cationic modifier such as diethylenetriamine, tetraethylene pentamine, guanidine, guanyl urea and oxazolidine as disclosed in published U.S. Patent Application US 2001/008874 A1 published on Jul. 19, 2001, for example U-RAMIN P-1500, trademark of Mitsui Kagaku K.K. of Shiodome City Center, Tokyo 105-7177, Japan a urea-formaldehyde pre-polymer modified with diethylene triamine.

The coating polymer(s) may also be added to a suspension of capsules that contain reactive components such that the coating becomes chemically (covalently) grafted to the capsule wall, or the coating polymer(s) may be added during the crosslinking stage of the capsule wall such that covalent partial grafting of the coating takes place.

Further, if stability of the capsule and coating system is compromised by inclusion in the product base, product forms which separate the bulk of the base from the fragrance composition may be employed. The cationic coated polymer particles of the present invention may be provided in solid and liquid forms depending on the other materials to be used. In order to provide the cationic coated polymer in a dry form, it is preferable that the materials be dried using drying techniques well known in the art. In a preferred embodiment the materials are spray dried at the appropriate conditions. The spray dried particles may also be sized to provide for consistent particle size and particle size distribution. One application in which it would be advantageous to include dry particles of the present invention would be incorporated in a powdered laundry detergent. Alternatively wet capsule-coating slurries may be absorbed onto suitable dry powders to yield a flowable solid suitable for dry product use.

The mechanism of action of the present invention is not completely understood at this time. It is thought that the cationic polymer solution coats and associates with the polymeric capsules, thus imparting a positive charge which interacts with either the base or substrate in such a way as to substantially improve capsule deposition to the substrate surface.

It should be noted that the cationic character of the polymer coating used is not sufficient to determine whether it is functional with regard to improving capsule or particle deposition. Without wishing to be bound by theory, it is hypothesized that while cationic charge provides an affinity to the normally anionic substrates of interest (i.e. hard surfaces), other physical characteristics of the polymer are also important to functionality. Additionally, interactions between the capsule or particle surface, base ingredients, and the coating polymer are thought to be important to improving deposition to a given substrate.

Use of the coating systems described below allows for more efficient deposition of capsules, particles, and dispersed droplets that are coated by the cationically charged polymer. Without wishing to be bound by any theory it is believed that the advantages of the coating systems is created by the combination of the cationically charged coating which is helpful in adhering to the substrate to which the product is applied with a capsule or particle containing fragrance. Once the encapsulated particle is adhered to the substrate we have found that the encapsulated fragrance can be delivered by the fracturing or compromising of the polymer coating by actions such as walking, wiping, dry-mopping, sweeping and the like.

In another embodiment of the invention the hard surface cleaning composition containing encapsulated materials can be added to nonwoven clothes used for mopping, wiping, dusting and cleaning hard surfaces.

The hard surface cleaning compositions of the present invention may contain uncoated or coated encapsulated fragrances. One measurement of the enhancement of the present invention in delivering the fragrance and other ingredients of the present invention is done by headspace analysis. Headspace analysis can provide a measure of the fragrance material contained on the desired substrate provided by the present invention. The present invention will provide a much higher level of fragrance on the substrate compared to the amount of fragrance deposited on the substrate by conventional means. As demonstrated by the following examples, the present invention can deliver more than about twice the level of fragrance to a substrate than common approaches, preferably more than about three times the level of fragrance and preferably more than about five times the level of fragrance than traditional approaches.

For example, this may be determined by measuring the level of fragrance imparted to a test floor samples containing fragrance in a hard surface cleaner by conventional means as compared to the level of fragrance imparted by the present invention. The same fragrance should be used and similar test floor samples should be washed in a similar manner. After dry-mopping to release the fragrance from the floor samples, the level of fragrance on the test floor samples of the control and the fragrance of the present invention could be measured by headspace analysis. Due to the superior retention of fragrance to floor samples by the present invention, the headspace analysis of the respective samples will demonstrate an improved level of fragrance as compared to fragrance applied by conventional means.

To better control and measure the fragrance release upon dry-mopping or rubbing from a substrate (i.e., floor sampels), a fixed-weight of the washed and dried substrate will be placed in a custom-made glass vessel containing SILCOSTEEL (Resteck Corp., Bellefont, Pa.) treated steel ball bearings. Headspace will be collected from the vessel using a Tenax trap (Supelco, Inc., Bellafonte, Pa.) upon equilibration. A second headspace will be collected after the substrate-containing vessel is shaken along with the steel beads on a flat bed shaker for 20 minutes. Fragrance present in the headspace from unshaken and shaken substrates and subsequently absorbed in the Tenax traps is desorbed through a Gerstel thermal desorption system (Gersteel, Inc., Baltimore, Md.). Desorbed fragrance volatiles are injected into a gas chromatograph (Hewlett-Packard, Model Agilent 6890) equipped with a flame ionization detector. Area counts of individual fragrance components, identified based on the retention time, are then collected and analyzed.

For the purposes of the present invention, hard surfaces include but are not limited to vinyl floors, ceramic tiles, wood, laminated floors, epoxy glass, etc. For the purposes of the invention “hard surface” is defined as a solid, substantially nonflexible, surface such as a countertop, bathroom tile, plumbing fixture wall, bathroom or kitchen wall, glass window, or linoleum floor. It does not include fabric, carpet, hair, skin, or other softer materials which are highly flexible.

In a preferred embodiment the hard surface cleaning composition comprises from about 50% to about 99.999% by weight of the composition of ingredients selected from the group consisting of detersive surfactants, builders, bleaching agents, enzymes, biocides, preservatives, fillers and mixtures thereof.

Hard surface cleaning compositions for use in accordance with the present invention contain relatively minor amounts of nonvolatile ingredients, a surfactant and a builder, along with a mixture of volatile ingredients, a combination of solvents, ammonia and water. Hard surface cleaning compositions are described in U.S. Pat. No. 3,453,144 to Morgan; U.S. Pat. No. 3,882,038 to Clayton et al; U.S. Pat. No. 3,709,825 to Chirash et al; U.S. Pat. No. 3,923,678 to Kleiner et al; U.S. Pat. No. 4,302,348 to Requejo; U.S. Pat. No. 4,152,305 to Berghausen, III; U.S. Pat. Nos. 3,956,161 and 3,966,628 to Woodward, U.S. Pat. No. 4,175,062 to Disch et al; U.S. Pat. No. 3,887,497 to Ulvild; U.S. Pat. No. 3,239,467 to Lipinski; U.S. Pat. No. 3,210,287 to Kelly et al, and U.S. Pat. No. 3,591,510 to Zenk.

All U.S. patents and patent applications cited herein are incorporated by reference as if set forth herein in their entirety.

These and additional modifications and improvements of the present invention may also be apparent to those with ordinary skill in the art. The particular combinations of elements described and illustrated herein are intended only to represent only a certain embodiment of the present invention and are not intended to serve as limitations of alternative articles within the spirit and scope of the invention. All materials are reported in weight percent unless noted otherwise. As used herein all percentages are understood to be weight percent.

### EXAMPLE 1

Long Lasting Application in a Wet Spray Application

Fragrance was added in the form of neat or capsule at a concentration of 0.29% fragrance equivalent to a commercial (bottled) solution with the following formulation:

| | | |
|---|---|---|
| 1. | Propylene glycol n-propyl ether or | 1% |
| | Propylene glycol n-butyl ether | |
| | (available from Dow Chemical) | |
| 2. | Synperonic A11 | 0.2% |
| | (a non-ionic surfactant - INCI name: | |
| | Trideceth-11 - by ICI) | |
| 3. | Ethanol | 1% |
| 4. | Fragrance and water balance | |
| | and a pH ranging from 7 to 9.5. | |

The solution was mixed well via a fine dispersion process (e.g. Silverson homogenizer), sprayed to a vinyl floor (purchased from Lowes store) at a rate of 2 grams of liquid/sq ft. The floor was wiped using the commercial pad as recommended, dried in the air for at least 10 minutes before being evaluated by a goup of evaluators. All three products were tested: the “AS IS” commercial product, the commercial product with added Neat fragrance and the commercial product with IFF capsule technology. The three different-treated floor materials were evaluated for residual fragrance intensity before and after simulated mopping by brushing the surface using a piece of paper towel.

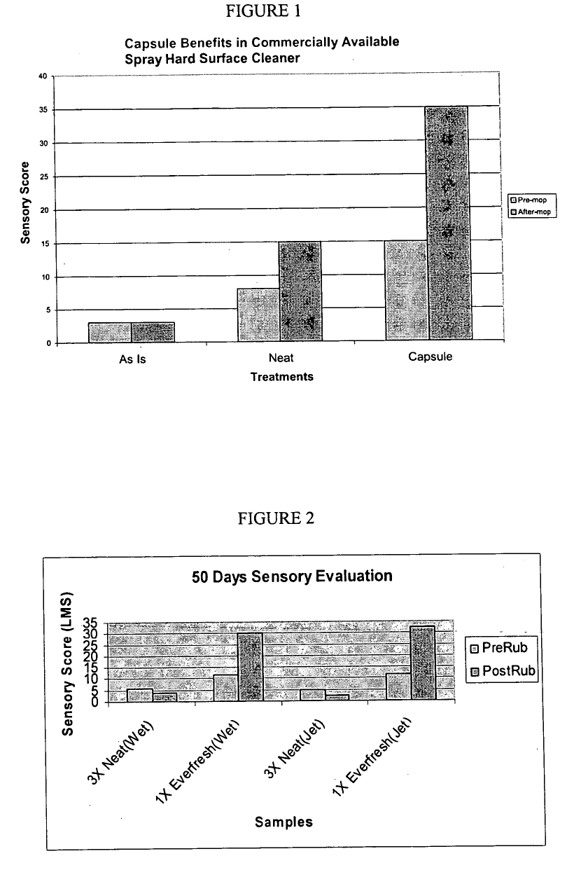

The results are illustrated in FIG. 1 wherein the evaluation scale is used:

Evaluation Scale:

| | |
|---|---|
| Barely detectable | 1.3 |
| Weak | 5.6 |
| Moderate | 16.7 |
| Strong | 33.1 |
| Very strong | 50.1 |

The neat control was clearly weaker, especially after scratching the vinyl surface in comparison to the capsule technology, demonstrating the superiority of the capsule technology. In real life applications, mopping the floor can occur during walking on the floor, breaking the capsule and releasing the fragrances.

Even after many days or weeks or months, the non-mopped floor tile still emitted strong freshness smell after mopping, see FIG. 2 which graphically depicts the benefits of Capsule technology of the present invention versus the 3 times neat in commercially available wet spray application.

### EXAMPLE 2

Long Lasting Benefits in All Purpose Cleaners

Long lasting benefits were also observed using the traditional “bucket and mop” method of floor cleaning with the capsule technology of the present invention. 0.70% neat fragrance was added to an all purpose cleaner base containing no fragrance with the following formulation:

| | | |
|---|---|---|
| 1. | BTC 2125 M | 0.5% |
| | (a biocide by Stepan company - | |
| | INCI name: myristalkonium chloride)) | |
| 2. | Dowanol PM | 3.0% |
| | (a solvent by Dow Chemical - | |
| | Methoxyisopropanol) | |
| 3. | Synperonic A11 | 3.0% |
| | (a non-ionic surfactant - | |
| | INCI name: Trideceth-11 - by ICI) | |
| 4. | water balance. | |
| | with a pH = 7.0. | |

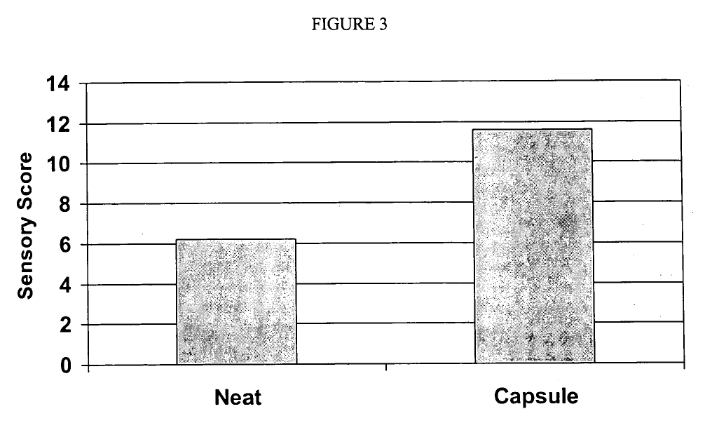

Another sample with 0.35% neat fragrance and 0.35% fragrance in capsule form were also prepared. The capsule was dispersed properly using a homogenizer and was suspended in the base with 0.3% Xanthum gum. Each solution was diluted to 10% original concentration and was applied to a vinyl floor sheet (1×1 sq ft) at a rate of 5 gram/sq ft. The surface was mopped using a sponge for a few minutes and let dry in the air. After drying, eight pieces of the 1×1 sq ft vinyl sheet was placed on the floor of each evaluation booth (without significant air flow) (3×4.7×8 cubic ft), either the vinyl treated with neat control or the Technology. The surface of the eight pieces of vinyl was dry-mopped using a paper towel attached to a dry mop head. The head space of the booth was evaluated by a group of judges and the intensity was statistically analyzed. See FIG. 3.

Both fresh and aged all purpose cleaner samples were evaluated according to the described procedure. The same conclusion was reached that the technology of the present invention delivers long lasting freshness in the air in all purpose cleaner products.

### EXAMPLES 3

Application in Hard Surface Cleaner Containing Neat and/or Capsule Technology

Two fragrances with different freshness character were synthesized: fragrance A and fragrance B. Some of fragrance B was encapsulated using IFF technology. 0.25% fragrance A and 0.25% fragrance B were formulated into a hard surface cleaning base having the same formulation as Example 2 as the neat traditional fragrance. The Technology sample contains 0.25% fragrance A neat and 0.25% fragrance B in capsule form. Thus, both the Neat and the Technology contain the same concentration of fragrance and the same composition. Both the neat and the Technology samples were diluted to 1.5% of original concentration before being applied to a vinyl floor in a booth of about 4×4×8 ft³, as a consumer would do. The booth was evaluated 30 minutes after application. Then both floors were dry-mopped using a paper towel, and headspace was evaluated again. For those trained in the art of fragrance evaluation, there is a distinct difference for the booth treated with Technology before and after mopping in the character of freshness.

### EXAMPLE 4

Application of Capsule Technology in Nonwoven Mopping Pad

Commercial nonwoven mopping cloths having the following formulation:

| | | |
|---|---|---|
| 1. | Propylene glycol n-propyl ether or | 1% |
| | Propylene glycol n-butyl ether | |
| | (available from Dow Chemical) | |
| 2. | Synperonic A11 | 0.2% |
| | (a non-ionic surfactant - | |
| | INCI name: Trideceth-11 - by ICI) | |
| 3. | Ethanol | 1% |
| 4. | Fragrance and water balance | |
| | and a pH ranging from 7 to 9.5. | |

The nonwoven mopping clothes were treated with either neat fragrance at a 0.24 gram per sheet ratio or with capsules at equal fragrance level, which were delivered in an aqueous dispersion form. One piece of cloth was used as directed to mop a 2×3 sq ft vinyl floor. This was repeated with cloths treated with the formulation+Neat and the formulation+Capsule. The floor was dried in air and evaluated before and after dry-mopping with pieces of paper tissue.

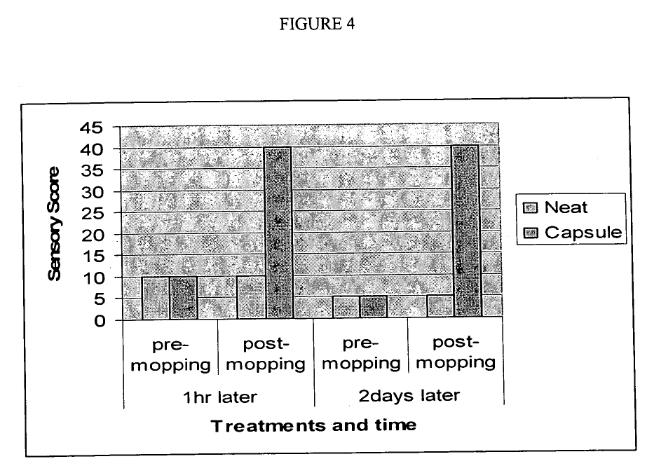

Before dry-paper mopping, the neat and capsule both have a weak and modest fragrance level within 30 minutes. The fragrance intensity decreased with time for tiles treated with either Neat or Technology, see FIG. 4. However, after mopping the surface with a piece of paper, the title with capsule technology clearly had a much stronger fragrance level than the title treated with neat fragrance control, see FIG. 2.

What is claimed is:

1. A hard surface cleaning composition comprising in admixture (i) a plurality of rupturable microcapsules each of which has (a) an outside diameter in the range of from about 0.01 to about 1000 microns; (b) a wall having a thickness in the range of from about 0.01 to about 100 microns; (c) a wall composed of a substituted or un-substituted acrylic acid polymer or co-polymer cross-linked with a melamine-formaldehyde pre-condensate or a urea-formaldehyde pre-condensate; and (d) a liquid phase monophasic core comprising a fragrance composition component and/or a malodour counteractant composition component, each of the components of which has a ClogP of from about 3.3 to about 8.0, the concentration of fragrance composition components and/or malodour counteractant composition components in the hard surface cleaning composition being in the range from about 0.01% to about 10% by weight of the hard surface cleaning composition, the range of weight percent of fragrance composition components and/or malodour counteractant composition in the plurality of microcapsules being from about 50% to about 97% by weight of filled microcapsules; and (ii) a hard surface cleaning base and optionally a thickener for maintaining in suspension said plurality of microcapsules.

2. The hard surface cleaning composition of claim 1 comprising in admixture (i) a plurality of rupturable microcapsules each of which has (a) an outside diameter in the range of from about 0.01 to about 1000 microns; (b) a wall having a thickness in the range of from about 0.01 to about 100 microns; (c) a wall composed of a substituted or un-substituted acrylamide-acrylic acid co-polymer cross-linked with a melamine-formaldehyde and/or a urea-formaldehyde pre-condensate; and/or a substituted or un-substituted C₁-C₄ alkyl acrylate-acrylic acid co-polymer cross-linked with a melamine-formaldehyde and/or a urea-formaldehyde pre-condensate; and/or a methacrylic acid-acrylic acid co-polymer cross-linked with a melamine-formaldehyde and/or a urea-formaldehyde pre-condensate and/or a substituted or un-substituted acrylic acid polymer cross-linked with a melamine-formaldehyde and/or a urea-formaldehyde pre-condensate; and (d) a liquid phase monophasic core consisting essentially of a fragrance composition component and/or a malodour counteractant composition component, each of the components of which has a Clog₁₀P of from about 3.3 to about 8.0 and (ii) a hard surface cleaning base for maintaining in suspension said plurality of microcapsules, the concentration of fragrance composition components and/or malodour counteractant composition components in said hard surface cleaning composition being in the range of from about 0.01 to about 10% by weight of said hard surface cleaning composition; the range of weight percent of fragrance composition components and/or malodour counteractant composition components in said plurality of microcapsules being from about 50% to about 97% by weight of filled microcapsules and the optional thickener is xantham gum being in the range from about 1% about 3%.

3. The hard surface cleaning composition of claim 1 wherein the fragrance composition component and/or malodour counteractant composition component has a ClogP of greater than about 4.0.

4. The hard surface cleaning composition of claim 1 wherein the capsule particle additionally comprises a solvent with a logP value of greater than 3.3.

5. The hard surface cleaning composition of claim 1 further comprising non-confined fragrance composition, which has a Clog P of from about 1 to about 8.

6. The hard surface cleaning composition of claim 4 wherein the solvent material is selected from the group consisting of triglyceride oil, mono and diglycerides, mineral oil, silicone oil, diethyl phthalate, polyalpha olefins and isopropyl myristate.

7. The hard surface cleaning composition of claim 1 wherein the microcapsules are coated with a cationically charged polymer and/or non-ionic polymer.

8. The hard surface cleaning composition of claim 7 wherein the polymer encapsulated fragrance is further coated by a cationic polymer selected from the group consisting of polysaccharides, cationically modified starch and cationically modified guar, polysiloxanes, poly diallyl dimethyl ammonium halides, copolymers of poly diallyl dimethyl ammonium chloride and vinyl pyrrolidone, acrylamides, imidazoles, imidazolinium halides, imidazolium halides and mixtures thereof.

9. The hard surface cleaning composition of claim 8 wherein the cationic polymer is selected from a cationically modified starch and cationically modified guar.

10. The hard surface cleaning composition according to claim 1, wherein the encapsulated fragrance composition accounts for from about 0.1 wt. % to about 1.4 wt. % of the total hard surface cleaning composition.

11. An article of manufacture comprising the hard surface cleaning composition of claim 1.

12. The hard surface cleaning composition of claim 1 wherein each of the plurality of rupturable microcapsules has a wall composed of an unsubstituted acrylamide-acrylic acid copolymer having a molecular weight in the range of from 5,000 to 1,000,000 cross-linked with a melamine-formaldehyde pre-condensate, wherein the mole ratio of acrylic acid monomeric units:acrylamide monomeric units is from 9:1 to 1:9 and wherein the mole ratio of melamine-formaldehyde precondensate cross-linking agent:acrylamide-acrylic acid copolymer is in the range of from 9:1 to 1:9.

13. The hard surface cleaning composition of claim 12 wherein the mole ratio of acrylic acid monomeric units:acrylamide monomeric units is from 7:3 to 3:7.

14. The hard surface cleaning composition of claim 12 wherein the mole ratio of melamine-formaldehyde precondensate cross-linking agent:acrylamide-acrylic acid copolymer is in the range of from 5:1 to 1:5.

15. The hard surface cleaning composition of claim 14 wherein the mole ratio of melamine-formaldehyde precondensate cross-linking agent:acrylamide-acrylic acid copolymer is in the range of from 2:1 to 1:2.

16. The hard surface cleaning composition of claim 12 wherein the unsubstituted acrylamide-acrylic acid copolymer has a molecular weight in the range of from 10,000 to 100,000.

17. The hard surface cleaning composition of claim 15 wherein the unsubstituted acrylamide-acrylic acid copolymer has a molecular weight in the range of from 10,000 to 100,000.

18. The hard surface cleaning composition of claim 12 wherein the melamine-formaldehyde precondensate is selected from the group consisting of a compound having the structure: 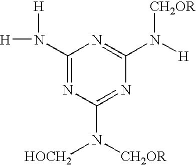
wherein R represents the same or different hydrogen and/or C₁-C₄ lower alkyl, dimers, trimers and tetramers thereof.

19. The hard surface cleaning composition of claim 12 wherein the melamine-formaldehyde precondensate is a compound having the structure: 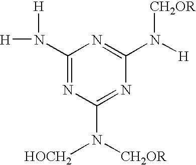
wherein R represents the same or different hydrogen and/or C₁-C₄ lower alkyl.

20. A method of making a hard surface cleaning product comprising:
providing a product base containing non-encapsulated fragrance composition components and/or malodour counteractant composition and surfactant material;
providing a permeable capsule material wherein the permeable capsule material contains greater than about 70 weight percent fragrance material and/or malodour counteractants and/or solvent having a ClogP value of greater than about 3.3;
allowing the non-encapsulated fragrance composition components and/or malodour counteractant composition and the permeable capsule material containing the fragrance material to come to equilibrium thereby transporting a portion of the non-encapsulated fragrance composition components and/or malodour counteractant composition through the permeable shell wall into the interior of the capsule and retaining the fragrance contents of the permeable capsule;
admixing the encapsulated material with a hard surface cleaning base; and
an optional step of admixing a nonencapsulated fragrance to the hard surface cleaning base; and
providing a hard surface cleaning product.

21. The method of claim 20 wherein the encapsulating polymer is selected from a vinyl polymer; an acrylate polymer, melamine-formaldehyde; urea formaldehyde and mixtures thereof.

22. The method of claim 20 wherein the encapsulated fragrance is coated with a cationic polymer.

23. The method of claim 21 wherein the cationic polymer is selected from polysaccharides, cationically modified starch and cationically modified guar, polysiloxanes, poly diallyl dimethyl ammonium halides, copolymers of poly diallyl dimethyl ammonium chloride and vinyl pyrrolidone, acrylamides, imidazoles, imidazolinium halides and imidazolium halides.

24. The method of claim 22 wherein the cationic polymer is selected from a cationically modified starch and cationically modified guar.

25. A method of making a hard surface cleaning composition comprising:
providing a sacrificial solvent having a ClogP value of from about 1 to about 3;
encapsulating the sacrificial solvent with a permeable encapsulate material;
providing the encapsulated sacrificial solvent in a liquid environment containing fragrance materials and/or malodour counteractants with ClogP of greater than about 3.3;
allowing the capsules containing the sacrificial solvent to come to equilibrium with the environment containing the high Clog P fragrance materials and/or malodour counteractants whereby at least 20 weight percent of the sacrificial solvent migrates from the capsule into the environment; and
admixing the encapsulated fragrance and/or malodour counteractants and/or solvent and external non-encapsulated fragrance with a hard surface cleaning base;
providing a hard surface cleaning composition.

26. The method of claim 25 wherein the sacrificial solvent has a ClogP of from about 1.25 to about 2.5.

27. The method of claim 26 wherein the sacrificial solvent is selected from the group consisting of benzyl acetate and octanol.

28. The method of claim 25 wherein at least about 40 weight percent of the sacrificial solvent migrates from the capsule interior to the environment.
